(19) United States
(12) Patent Application Publication
(10) Pub. No.: US 2018/0279773 A1
(43) Pub. Date: Oct. 4, 2018

(54) Stand, In Particular For Laptops Or Notebooks

(71) Applicant: Adam Hall GmbH, Neu-Anspach (DE)

(72) Inventors: Markus Rink, Coburg (DE); Robin Henlich, Usingen (DE)

(73) Assignee: Adam Hall GmbH

(21) Appl. No.: 15/940,042

(22) Filed: Mar. 29, 2018

(30) Foreign Application Priority Data
Mar. 31, 2017 (DE) 202017101917.9

(51) Int. Cl. A47B 23/04

(52) U.S. Cl. CPC A47B 23/043; F16M 11/2021; A47B 2023/049

(57) ABSTRACT

Provided is a stand, in particular for laptops or notebooks, including a support positioned upright and having a top and a bottom end areas, at least one rest pivotably arranged at the top end area of the support about a first pivot axis, and an adjustment device for adjusting and fixating the rest. The adjustment device has a guide part to be guided within a motion link of the support along its longitudinal axis, and at which a first end area of a lever arrangement is mounted. The adjustment device further has a connecting part arranged at the rest at which a second end area of the lever arrangement is pivotably mounted about a second pivot axis. The second pivot axis is arranged in parallel to the first pivot axis, and the adjustment device has a fixation device so that the guide part is fixated at a set position.

### CROSS-REFERENCE TO RELATED APPLICATION

This application claims the benefit of priority to German Utility Model Registration No. 202017101917.9 filed on Mar. 31, 2017, the disclosure of which is incorporated herein by reference in its entirety.

### TECHNICAL FIELD

The present disclosure relates to a stand that is particularly suitable for laptops, notebooks, or the like.

### RELATED ART

A stand, such as the one disclosed in US 2011/0147547 A1, generally has a support plate attached at a rack in a pivotable manner, with the rack comprising two upright supports having a top end at which a crossbar is attached, with a support plate being arranged at the crossbar in a pivotable manner. A floor mount is arranged at the bottom end of the supports, comprising a crossbar that is connected to the supports at their bottom end, and with a longitudinally oriented support being attached at its center.

### SUMMARY

The objective of the present disclosure is to create a stand that is versatile and easy to handle.

In particular, what is disclosed is a stand that firstly has the advantage that it preferably needs only one single support which in its operating position can be aligned in an upright position, in particular perpendicularly, relative to the installation plane.

A rest can be attached at least in one top end area of the support, with the rest being arranged so as to be pivotable about a first pivot axis relative to the support, and thus can take different pivot positions. For this purpose, an adjustment device may be provided by means of which the respective pivot positions can be set and these pivot positions can be fixated. If the rest is to be transferred into a different pivot position, the fixation may of course also be released by means of the adjustment device.

Correspondingly, the stand according to the present disclosure is in particular suitable for users who work standing up. For them, the stand according to the invention can offer a better operability and, if arranged on a table, a better use of the placement area.

There are advantageous further developments of the present disclosure.

Thus, it is possible to arrange a rest also at the bottom end area, which is formed identical to the upper rest with respect to its design and its adjustment device, and only has to be arranged at the support in a mirror-inverted manner as compared to the upper rest.

Further, it is possible to hook in an additional tray plate at the support, for which purpose the support can have a plurality of hook-in recesses that are arranged on top of each other and below each other as viewed along its longitudinal axis, so that the additional tray plate can be arranged at the support at different distances to the upper—and optionally also the lower—rest.

This variably usable additional tray plate offers additional stowage space, for example for external power units or peripheral devices such as for example audio AD/DA converters, which are also referred to as audio interfaces.

Due to its construction, the stand according to the invention can be folded quickly to a very flat transport size, which results in the advantage of a further simplification of the operability.

As an additional feature, it is possible to hook in a table clip at the support, so that the stand can be connected to the top of a table in a firmly fixed and safe manner.

However, it is also possible to use the lower rest as a support of the stand on a base surface.

According to one exemplary embodiment of the present disclosure, the stand, in particular for laptops or notebooks, may include a support that is positioned upright in an operating position and that has a top end area and a bottom end area, at least one rest that is arranged at the top end area of the support so as to be pivotable about a first pivot axis, and an adjustment device for adjusting the rest in different pivot positions and for fixating the respectively set pivot position. The adjustment device may have a guide part that is guided in a displaceable manner inside a motion link of the support along its longitudinal axis, and at which a first end area of a lever arrangement is mounted, and the adjustment device may further have a connecting part that is arranged at the rest at which a second end area of the lever arrangement is mounted so as to be pivotable about a second pivot axis, wherein the second pivot axis is arranged in parallel to the first pivot axis and offset from the same by a predetermined distance, and the adjustment device has a fixation device by means of which the guide part is configured to be fixated in the respectively set displacement position.

In addition, the lever arrangement may have two connecting levers that are arranged at a distance from and in parallel to each other. Also, the rest may be displaceable in a stepless manner or in a stepwise manner. The rest may be embodied as a full-surface plate or comprise five elongated support sections that are connected to each other, wherein end stops are arranged at free ends of the support sections.

The stand may further comprise a second rest arranged at the bottom end area and a tray plate suspended at the support at selectable positions. The tray plate may have a suspension hook that meshes into one of a plurality of recesses of the support, and a supporting stop resting against the support is arranged opposite the suspension hook.

Further, the stand may further include a table clip attached at the bottom end area, wherein the table clip has a clamp.

The fixation device of the stand may be embodied as a cam-type closure, wherein a toothing with one partial toothing at each side of the motion link may be provided. The fixation device of the adjustment device may have clamping jaws that are made of a plastic material and have a smooth support surface for resting against the toothing.

### BRIEF DESCRIPTION OF THE DRAWINGS

These and/or other aspects will become apparent and more readily appreciated from the following description of the exemplary embodiments, taken in conjunction with the accompanying drawings.

FIG. 1 shows a perspective schematics of an exemplary embodiment of a stand according to the present disclosure,

FIG. 2 shows a side view of the stand according to FIG. 1,

FIGS. 3 to 5 show detailed illustrations of the stand according to FIGS. 1 and 2,

FIG. 6 shows a front view of the stand of FIGS. 1 and 2, and

FIG. 7 shows a perspective partial view of a bottom fixation device of the stand according to the present disclosure.

### DETAILED DESCRIPTION

Hereinafter, a stand according to an exemplary embodiment of the present disclosure will be described with reference to the accompanying drawings to allow those skilled in the art to easily practice the present disclosure. Advantages and features of the present disclosure and methods for achieving the same will be clearly understood with reference to the following detailed description of exemplary embodiments in conjunction with the accompanying drawings. However, the present disclosure is not limited to the exemplary embodiments disclosed herein, but may be implemented in various different forms. The exemplary embodiments are merely given to make the disclosure of the present disclosure complete and to completely instruct the scope of the disclosure to those skilled in the art, and the present disclosure should be defined by the scope of the claims.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, in order to make the description of the present disclosure clear, unrelated parts are not shown and, the thicknesses of layers and regions are exaggerated for clarity.

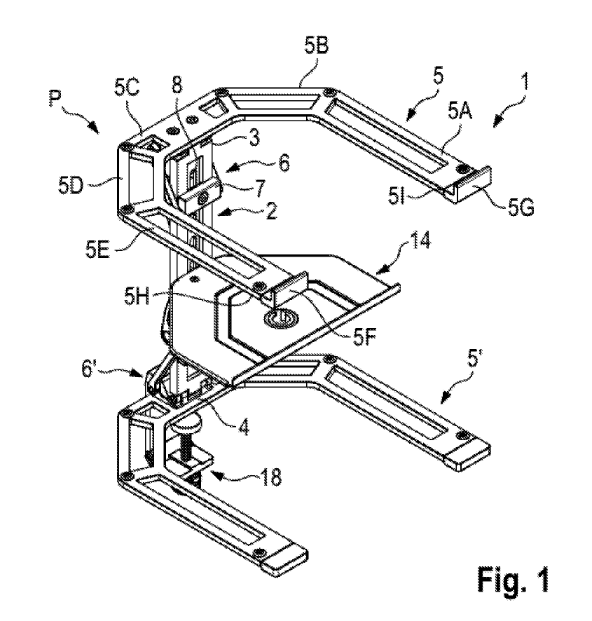

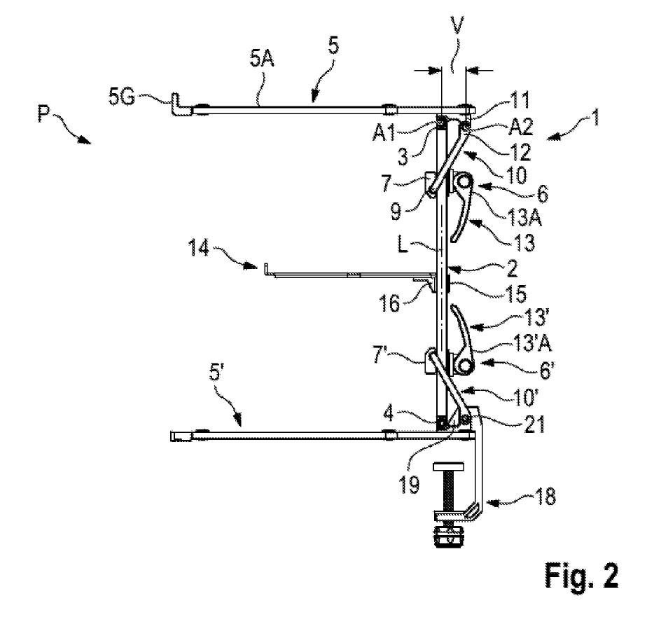

Viewed in combination, FIGS. 1 and 2 show the basic structure of the stand according to the present disclosure, which is in particular suitable for laptops, notebooks or other objects that have to be deposited at least temporarily.

For this purpose, the stand 1 may have a rest 5 that is attached at the support 2. FIGS. 1 and 2 show the operating position P, in which the support 2 extends at least upright, but as a general rule perpendicular with respect to an installation plane. As can be seen from FIGS. 1 and 2, the support 2 may have an end area 3 that in this operating position P is a top end area, as well as a bottom end area 4.

The rest 5 may be arranged at the top end area 3 in a pivotable manner. The pivot axis A1, about which the rest 5 can be pivoted, is illustrated in FIG. 2.

Further, the stand 1 may have an adjustment device which is identified by the reference number 6 in its entirety. This adjustment device 6 serves for setting a certain pivot position of the rest 5, such as the position according to FIGS. 1 and 2, in which the rest 5 is arranged horizontally or at a right angle with respect to the support 2. The adjustment device 6 serves for setting this pivot position, which may also be a pivot position that is inclined at an acute angle with respect to the support 2, and further the set pivot position of the rest 5 can be temporarily fixated or can be released again to change its pivot position by means of the adjustment device 6.

For this purpose, the adjustment device 6 may have a guide part 7 that is guided within a motion link 8. The motion link 8 can be an oblong hole which makes it possible for the guide part 7 to be moved up and down on the support 2 according to its longitudinal extension L (see FIG. 2). For this purpose, the guide part 7 can be connected to a counter-piece that is arranged on the opposite side of the support 2, for example by means of a screw connection, wherein the screw of the screw connection extends inside the motion link 8. The different displacement positions that can be selected by the guide part 7 correspond to a pivot position of rest 5. The adjustment device 6 may further have a lever arrangement 10 that is arranged—in particular in a pivotable manner—at the guide part 7 at a first end area 9. At a second end area 12 of the lever arrangement 10, the lever arrangement 10 may be mounted at a connecting part 11. This mounting is realized about a second pivot axis A2, which is arranged so as to be parallel to the first pivot axis A1 and offset from it by an offset V, as illustrated in FIG. 2. Here, the two pivot axes Al and A2 are aligned in parallel to each other. This means that the lever arrangement 10 may form a connection between the longitudinally displaceable guide part 7 and the rest 5. Finally, the adjustment device 6 may have a fixation device 13, of which a handle 13A can be seen in FIG. 2. This fixation device 13 serves for fixating or releasing the respective displacement position of the guide part 7 through corresponding actuation. FIG. 2 shows a fixation position of the handle 13A, wherein the fixation device 13 is preferably embodied as a cam-type closure. However, it is also possible to provide different fixation devices for fixating the displacement position of the guide part 7, such as for example a simple screw connection that can be provided with a manually operable wing nut which can be tightened for fixating the displacement position and loosened for releasing the displacement position.

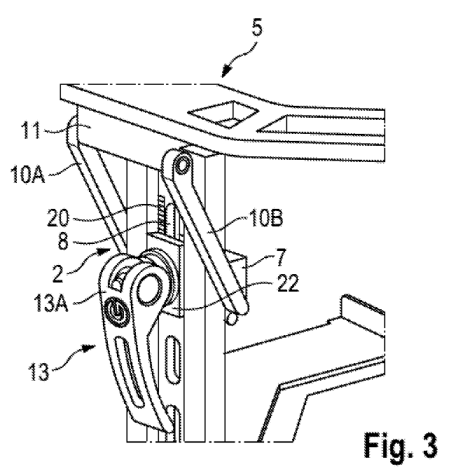

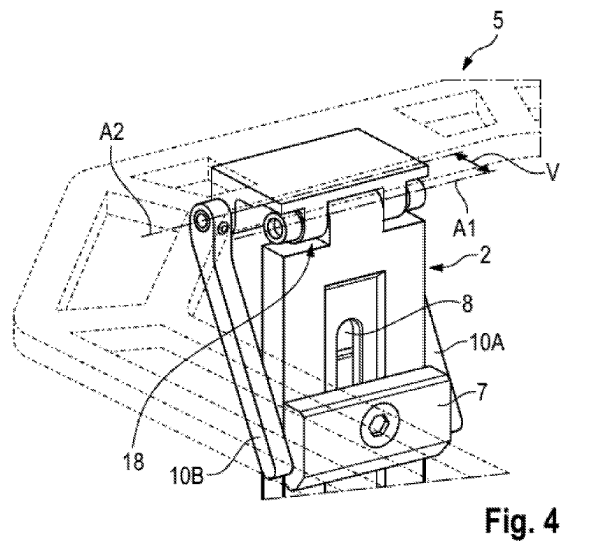

The detailed illustrations of FIGS. 3 and 4 illustrate that, in the exemplary embodiment shown in FIGS. 1 and 2, the lever arrangement 10 may include two connecting levers 10A and 10B. These two levers 10A and 10B may be disposed at a distance from each other corresponding to the width of the guide part 7, as they are arranged laterally at the guide part 7 with their bottom end area 9 in the embodiment shown in FIGS. 3 and 4. In the top end area 10, FIGS. 3 and 4 show the connecting part 11, which can be an integral component of the rest 5 or may be a separate structural component that can be fixated at the rest 5 in a suitable manner. Here, FIG. 4 once more illustrates the position of the two pivot axes Al and A2 as well as their offset V with respect to one another. The pivot axis A1 may be the geometrical axis of a hinge 18 by means of which the rest 5 can be attached at the support 2 in a pivotable manner.

The pivotable mounting of the connecting levers 10A and 10B at the connecting part 11 can for example be a bolt that extends through the connecting part 11, and can be fixated with its end areas inside the lugs of the connecting lever 10A and 10B. Here, too, other pivot bearings are conceivable.

Further, it is possible to provide a stepless pivotability for the rest 5, or also a stepwise pivotability, for example by means of a locking arrangement as it is indicated in FIG. 3 and identified by the reference number 20.

The rest 5 can be embodied either as a full-surface plate or, as is in particular shown in

FIG. 1, as a structural component that is comprised of elongated support sections 5A to 5E. Here, FIG. 1 illustrates that, due to the chosen angled orientation of these support sections 5A to 5E with respect to each other, a U-like configuration is created in the assembled state, with the support sections 5A and 5E being provided in parallel and at a distance to one another. Here, the free ends 5H and 51 of the support sections 5A or 5E may be provided with end stops 5G or 5F that prevent a deposited part, such as for example a laptop, from slipping off the rest 5 in the case that the rest 5 has a tilted orientation.

The support sections 5A to 5E can be comprised of a single-piece structural component or separate components that are connected to each other, for example by means of bonding or welding. Further, the support sections 5A to 5E can be provided with central recesses to reduce their weight, as can in particular be seen in FIG. 1.

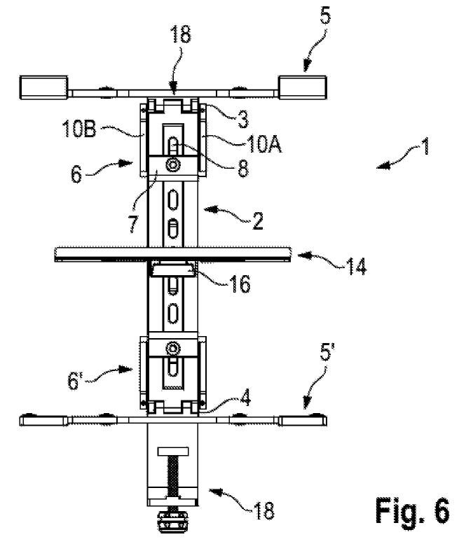

In addition to the rest 5 at the top end area of the support 2, the exemplary embodiment shown in FIGS. 1, 2 and 6 may have a further rest 5′ at the bottom end area 4, as is shown by a synopsis of these Figures. This rest 5′, too, may be provided with an adjustment device 6′, wherein the rest 5′ as well as the adjustment device 6′ may correspond to the previously described rest 5 and adjustment device 6 with respect to their structure and function, so that the above explanations may be referred to in this context. However, as FIG. 2 illustrates, the rest 5′ and the associated adjustment device 6′ may be arranged at the support 2 in a mirror-inverted manner as compared to the rest 5 with the adjustment device 6, which may for example mean that the handle 13A′ points upwards, while the handle 13A of the adjustment device 6 points downwards, as may be seen in FIG. 2.

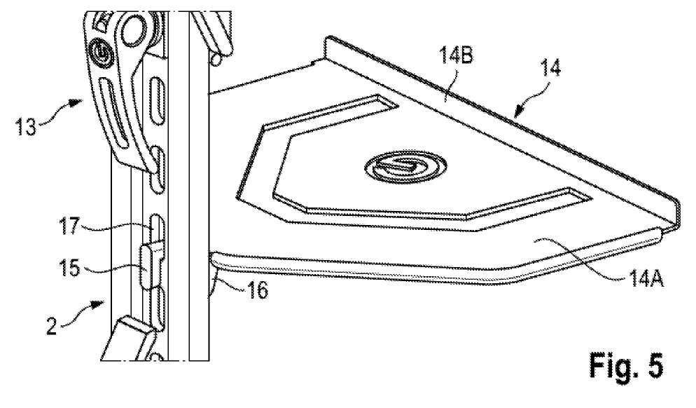

Further, the exemplary embodiment shown in FIGS. 1, 2 and 6 may have an additional tray plate 14 that can be suspended at the support 2 at selectable positions. For this purpose, the tray plate 14 may have a suspension hook 15 that can mesh with one of a plurality of recesses 17 of the support 2, which may in particular be seen in a synopsis of FIGS. 2 and 5. On that side of the support 2 that is located opposite the suspension hook 15, the tray plate 14 may be further provided with a supporting stop 16 that in the suspended state is supported at a wall area of the support 2 and thus secures the position of the tray plate 14 relative to the support 2, which can be seen in the rendering of the FIG. 2.

Finally, the exemplary embodiment of the stand 1 according to the present disclosure shown in FIGS. 1, 2 and 6 may be provided with a table clip 18 at the bottom end area 4. This table clip 18 can be hooked into the bottom end area. For this purpose, it may have a clamp 19 that engages around a connecting rod of the two lever arms of the lever arrangement 10′, which can be seen in FIG. 2. This connecting rod is shown in FIG. 2 in a schematically simplified manner and indicated by reference number 21.

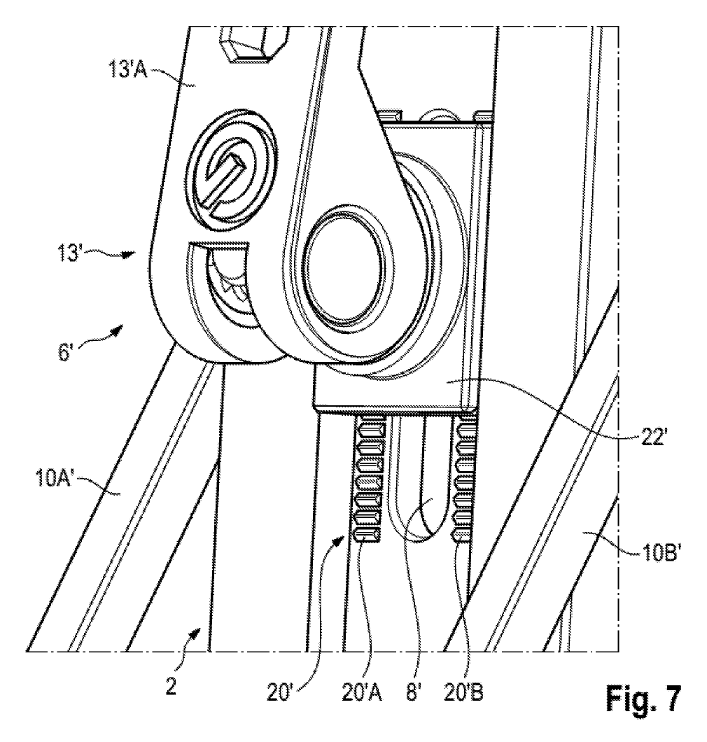

FIG. 7 shows an enlarged partial view of the bottom adjustment device 6′ shown in FIGS. 1 and 2, and regarding its structure that corresponds to the structure of the adjustment device 6. In connection with FIG. 3, a latching mechanism 20 has been described. It may be also provided in the bottom adjustment device 6′, where it is indicated by the reference number 20′. This latching mechanism or toothing may have two partial toothings 20′A and 20′B that are respectively arranged on both sides of the motion link 8′ across its entire length. FIG. 7 further shows that, apart form the handle 13′A, the fixation device 13′ may further have clamping jaws 22′, with the handle 13′A being arranged on the outer side thereof. Via a connecting part that is not shown in FIG. 7, these clamping jaws 22′ may be connected to a guide part 7′, which is also not shown in FIG. 7, but can be seen in FIG. 2.

Like toothing 20, the toothing 20′ can act together with a counter-toothing of the clamping jaws 22′ or 22 to facilitate a stepwise adjustment of the guide part 7 or 7′.

However, it is also possible to use the toothing with clamping jaws 22 or 22′ that are formed with a smooth surface on the side that is resting against the toothing 20′, so that a stepless adjustability of the guide part 7 or 7′ may still be facilitated. If the clamping jaws 22′ or 22 are made of a plastic material, it is possible that the teeth of the toothing 20′A, 21′B slightly burrow into the material of the clamping jaws 22′ resting thereon, so that the stability of the fixation device of the stand according to the invention 1 is increased.

Since, as mentioned, the adjustment devices 6 and 6′ may be embodied in an identical manner, the above explanation regarding FIG. 7 also applies to adjustment device 6.

In addition to the above written description of the disclosure, the illustration of the disclosure in the drawings of FIGS. 1 to 7 is herewith explicitly referred to for additionally disclosing the invention.

### PARTS LIST

1 stand
2 support
3 top end area
4 bottom end area
5 rest
5A-5E support sections
5F, 5G end stops
5H, 5G free end
6, 6′ adjustment device
7 guide part
8 motion link
9 first end area
10 lever arrangement
10A, 10B connecting lever
11 connecting part
12 second end area
13 fixation device
13A handle
14 tray plate
15 claim/suspension hook
16 supporting stop
17 recesses that are arranged on top of each other along support 2
18 table clip
19 clamp/suspension hook
20 latching mechanism
21 connecting bolt
A1, A2 pivot axes
L longitudinal extension/longitudinal axis of the support 2
P operating position
V offset

1. A stand, in particular for laptops or notebooks, comprising:
a support that is positioned upright in an operating position and that has a top end area and a bottom end area;
at least one rest that is arranged at the top end area of the support so as to be pivotable about a first pivot axis; and
an adjustment device for adjusting the rest in different pivot positions and for fixating the respectively set pivot position,
wherein the adjustment device has a guide part that is guided in a displaceable manner inside a motion link of the support along its longitudinal axis, and at which a first end area of a lever arrangement is mounted, and
wherein the adjustment device further has a connecting part that is arranged at the rest at which a second end area of the lever arrangement is mounted so as to be pivotable about a second pivot axis, wherein the second pivot axis is arranged in parallel to the first pivot axis and offset from the same by a predetermined distance, and the adjustment device has a fixation device by means of which the guide part is configured to be fixated in a respectively set displacement position.

2. The stand according to claim 1, wherein the lever arrangement has two connecting levers that are arranged at a distance from and in parallel to each other.

3. The stand according to claim 1, wherein the rest is displaceable in a stepless manner.

4. The stand according to claim 1, wherein the rest is displaceable in a stepwise manner.

5. The stand according to claim 1, wherein the rest is embodied as a full-surface plate.

6. The stand according to claim 1, wherein the rest comprises five elongated support sections that are connected to each other.

7. The stand according to claim 6, wherein end stops are arranged at free ends of the support sections.

8. The stand according to claim 1, further comprising a second rest arranged at the bottom end area.

9. The stand according to claim 1, further comprising a tray plate suspended at the support at selectable positions.

10. The stand according to claim 9, wherein the tray plate has a suspension hook that meshes into one of a plurality of recesses of the support, and a supporting stop resting against the support is arranged opposite the suspension hook.

11. The stand according to claim 1, further comprising a table clip attached at the bottom end area.

12. The stand according to claim 11, wherein the table clip has a clamp.

13. The stand according to claim 1, wherein the fixation device is embodied as a cam-type closure.

14. The stand according to claim 1, wherein a toothing with one partial toothing at each side of the motion link is provided.

15. The stand according to claim 1, wherein the fixation device of the adjustment device has clamping jaws that are made of a plastic material and have a smooth support surface for resting against the toothing.
